(19) United States
(12) Patent Application Publication
(10) Pub. No.: US 2024/0406291 A1
(43) Pub. Date: Dec. 5, 2024

(54) HYBRID GROUP MESSAGING

(71) Applicant: Apple Inc., Cupertino, CA (US)

(72) Inventors: Stephen M. LOTTERMOSER, San Jose, CA (US); Christopher A. VOLKERT, San Francisco, CA (US); Conner IRWIN, Cupertino, CA (US)

(21) Appl. No.: 18/530,146

(22) Filed: Dec. 5, 2023

Related U.S. Application Data
(60) Provisional application No. 63/470,963, filed on Jun. 4, 2023.

(51) Int. Cl. H04L 69/18; H04L 51/216

(52) U.S. Cl. CPC H04L 69/18; H04L 51/216

(57) ABSTRACT

The subject system may be implemented by at least one processor configured to generate a message comprising content and an identifier and transmit the message to a plurality of other electronic devices via a cellular messaging protocol and substantially concurrently via an internet-based messaging protocol.

### CROSS-REFERENCE TO RELATED APPLICATIONS

The present application claims the benefit of U.S. Provisional Patent Application Ser. No. 63/470,963, entitled “HYBRID GROUP MESSAGING,” filed Jun. 4, 2023, which is hereby incorporated herein by reference in its entirety and made part of the present U.S. Utility Patent Application for all purposes.

### TECHNICAL FIELD

The present description generally relates to messaging between electronic devices and, more particularly, to messaging between a group of electronic devices communicating via two or more messaging protocols.

### BACKGROUND

An electronic device such as a laptop, tablet, smartphone, or wearable device may exchange messages with a group of one or more other electronic devices.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for group messaging, in accordance with one or more implementations.

FIG. 2 depicts an example electronic device that may implement the subject methods and systems, in accordance with one or more implementations.

FIG. 3 depicts an example of an electronic device sending a message to other electronic devices via multiple messaging protocols, in accordance with one or more implementations.

FIG. 4 depicts an example of an electronic device receiving a message from another electronic device via multiple messaging protocols, in accordance with one or more implementations.

FIG. 5 depicts an example of an electronic device receiving a message from another electronic device via a messaging protocol, in accordance with one or more implementations.

FIG. 6 depicts an example message thread of an electronic device sending a message to other electronic devices via multiple messaging protocols and receiving a message from another electronic device via a messaging protocol, in accordance with one or more implementations.

FIG. 7 depicts an example message thread of an electronic device receiving a message from another electronic device via a messaging protocol, in accordance with one or more implementations.

FIG. 8 depicts an example message thread of an electronic device updating a previous received message, in accordance with one or more implementations.

FIG. 9 depicts a flow diagram of an example process for sending group messages in a hybrid group, in accordance with one or more implementations.

FIG. 10 depicts a flow diagram of an example process for receiving group messages in a hybrid group, in accordance with one or more implementations.

FIG. 11 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Multiple electronic devices may participate in a message group. Each of the electronic devices may be capable of communicating messages to the message group via a cellular messaging protocol and/or via an internet-based messaging protocol. Group messaging platforms may face challenges when attempting to interoperate different messaging protocols. These issues may include degradation of message quality and lack of feature compatibility, due to the incompatibilities between the cellular messaging protocols and internet-based messaging protocols.

The subject technology enables hybrid group messaging by allowing compatible devices in a message group to communicate via feature-rich internet-based messaging protocols while maintaining communication via cellular messaging protocols with other devices in the group that are incompatible with the internet-based messaging protocol. To preserve message quality, aspects of the subject technology leverage unique identifiers to identify and handle duplicate messages across the different messaging protocols so that electronic devices capable of the internet-based messaging protocol can provide and/or present the highest quality version of the message without duplicates.

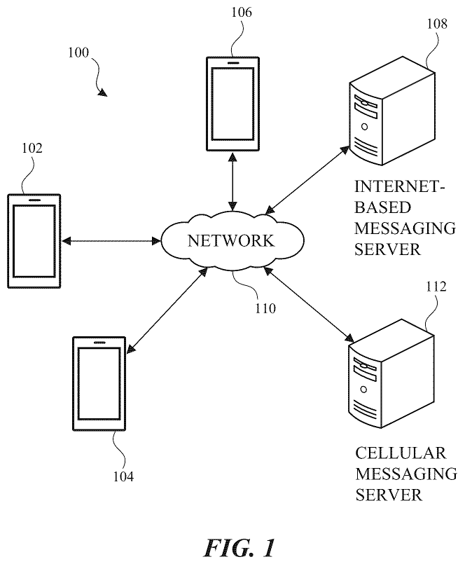

FIG. 1 illustrates an example network environment 100 for group messaging, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, an electronic device 104, an electronic device 106, and one or more servers (e.g., a server 108). The network 110 may communicatively (directly or indirectly) couple the electronic device 102, the electronic device 104, the electronic device 106, and/or the server 108. In one or more implementations, the network 110 may be an interconnected network of devices that may include, or may be communicatively coupled to, the internet. For explanatory purposes, the network environment 100 is illustrated in FIG. 1 as including the electronic device 102, the electronic device 104, the electronic device 106, and the server 108; however, the network environment 100 may include any number of electronic devices and/or any number of servers communicatively coupled to each other directly and/or via the network 110.

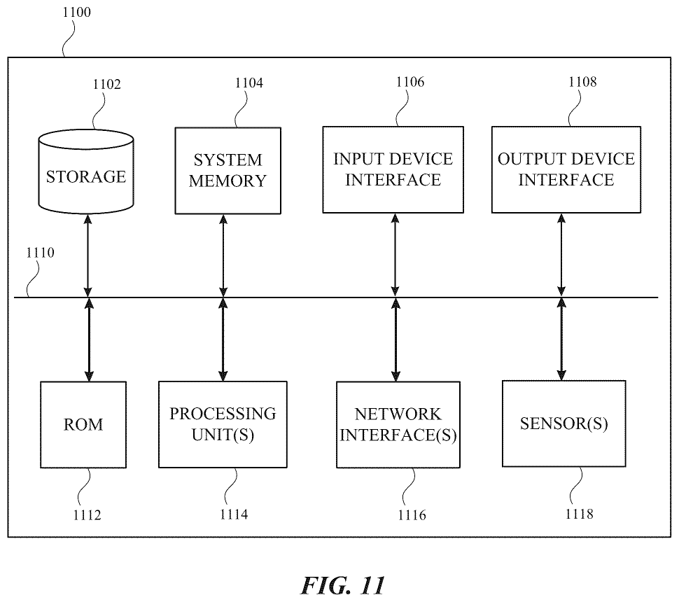

The electronic device 102 may be, for example, a desktop computer, a portable computing device such as a laptop computer, a smartphone, a peripheral device (e.g., a digital camera, headphones), a tablet device, a wearable device (e.g., a watch, a band, and the like), or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a smartphone. The electronic device 102 may be, and/or may include all or part of, the electronic system discussed below with respect to FIG. 11. In one or more implementations, the electronic device 102 may include an electronic display (e.g., a touchscreen) with which a user may interact with a digital keyboard (e.g., to generate a message). For example, to interact with a digital keyboard, the user may press (e.g., touch-down and/or touch-up input on the touchscreen) on one or more elements of the digital keyboard corresponding to one or more letters to form one or more words. The electronic device 102 may be configured to send one or more messages to one or more other electronic devices via one or more messaging protocols (e.g., cellular messaging protocol and/or internet-based messaging protocols).

The electronic device 104 may be, for example, a portable computing device such as a laptop computer, a smartphone, a peripheral device (e.g., a digital camera, headphones), a tablet device, a wearable device such as a watch, a band, and the like, any other appropriate device that includes, for example, one or more wireless interfaces, such as WLAN radios, cellular radios, Bluetooth radios, Zigbee radios, NFC radios, and/or other wireless radios. In FIG. 1, by way of example, the electronic device 104 is depicted as a smartphone. The electronic device 104 may be, and/or may include all or part of, the electronic system discussed below with respect to FIG. 11. The electronic device 104 may be configured to send one or more messages to one or more other electronic devices via one or more messaging protocols (e.g., cellular messaging protocol and/or internet-based messaging protocols).

The electronic device 106 may be, for example, a portable computing device such as a laptop computer, a smartphone, a peripheral device (e.g., a digital camera, headphones), a tablet device, a wearable device such as a watch, a band, and the like, any other appropriate device that includes, for example, one or more wireless interfaces, such as WLAN radios, cellular radios, Bluetooth radios, Zigbee radios, NFC radios, and/or other wireless radios. In FIG. 1, by way of example, the electronic device 104 is depicted as a smartphone. The electronic device 104 may be, and/or may include all or part of, the electronic system discussed below with respect to FIG. 11. The electronic device 106 may be configured to send one or more messages to one or more other electronic devices via one or more messaging protocols (e.g., cellular messaging protocol and/or internet-based messaging protocols).

In one or more implementations, one or more servers such as the server 108 and the server 112 may perform operations for managing the secure exchange of communications data (e.g., messages) and/or communications sessions data between various electronic devices such as the electronic device 102, the electronic device 104, and/or the electronic device 106, such as during a group communications session (e.g., a group message). The server 108 may facilitate communication of messages via one or more internet-based messaging protocols. The server 112 may include various cellular infrastructure (e.g., cellular carrier 308) that facilitates the communication of messages via one or more cellular messaging protocols (e.g., SMS (Short Message Service)). In some examples, the server 108 includes one or more app-specific modules (e.g., plugins) that perform operations for a respective application. In some variations, the server 108 includes one or more push modules for providing asynchronous notifications to one or more electronic devices (e.g., publish-subscribe messaging).

In one or more implementations, the server 108 may also or instead store account information (e.g., account, handles, or any other account-specific data) associated with the electronic device 102 and/or the electronic device 104, and/or users of those devices.

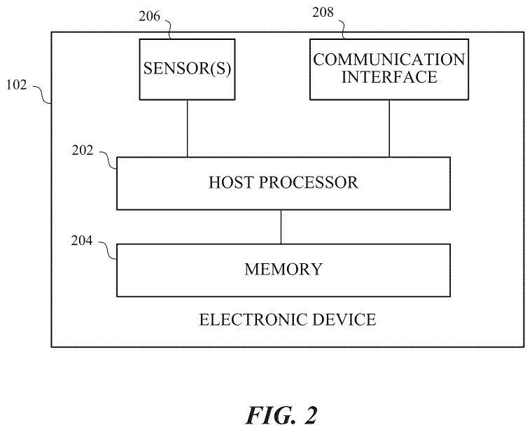

FIG. 2 depicts an example electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, one or more sensor(s) 206, and/or a communication interface 208. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store user location data, images (e.g., photos, digital stickers, and the like), messages, account data (e.g., login information, user IDs, and the like), and any other data generated in the course of performing the processes described herein.

The sensor(s) 206 may include one or more microphones and/or image sensors. The microphones may be used to facilitate the text input to an application by a user via, for example, a speech-to-text interface. The image sensors may be used to capture images for sending to electronic devices in a group.

The communication interface 208 may include suitable logic, circuitry, and/or code that enables wired or wireless communication, such as between the electronic device 102 and the server 108. The communication interface 208 may include, for example, one or more of a Bluetooth communication interface, an NFC interface, a Zigbee communication interface, a WLAN communication interface, a USB communication interface, a cellular interface, or generally any communication interface. The communication interface 208 may be configured to send messages in one or more messaging protocols including one or more cellular messaging protocols and/or one or more internet-based messaging protocols.

In one or more implementations, one or more of the host processor 202, the memory 204, the sensor(s) 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

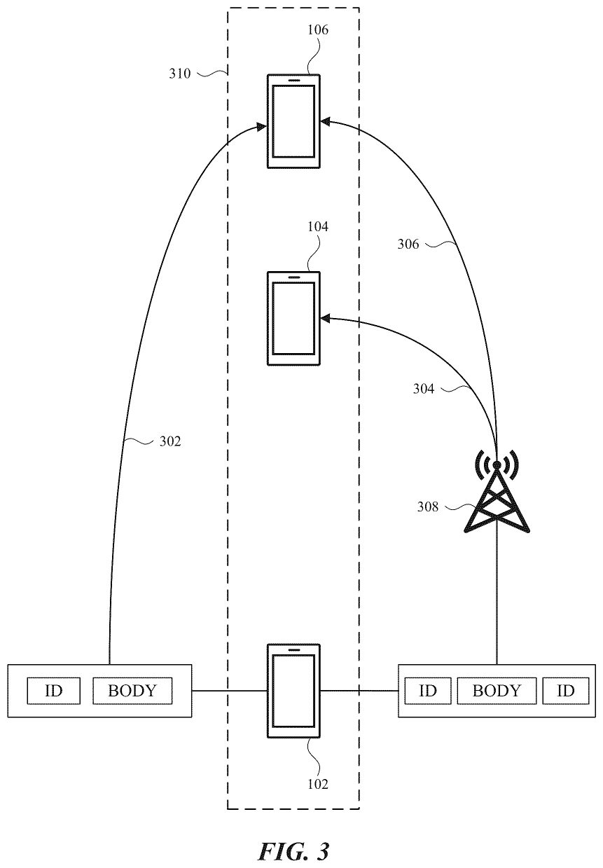

FIG. 3 depicts an example of an electronic device 102 sending messages to other electronic devices (e.g., the electronic device 104 and the electronic device 106) via multiple messaging protocols, in accordance with one or more implementations. For explanatory purposes, FIG. 3 is primarily described herein with reference to the electronic device 102, the electronic device 104, and the electronic device 106 of FIG. 1 in a messaging group 310. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the context of a messaging group 310 including the electronic device 102, the electronic device 104, and the electronic device 106, the electronic device 102 and the electronic device 106 may communicate via an internet-based messaging protocol and a cellular messaging protocol (e.g., SMS (Short Message Service) and/or MMS (Multimedia Messaging Service)) and the electronic device 104 may only communicate via the cellular messaging protocol. The electronic devices 102, 104, and 106 may communicate with each other via messages that are displayed within a message thread. The message thread may be associated with a respective messaging application running on each of the electronic devices 102, 104, and 106. For example, the messaging application may be one or more of an instant messaging application, an email application, a text message application, or another type of application that provides for electronic messaging between the electronic devices 102, 104, and 106. The messaging application (e.g., instant messaging, email, text message) may be the same, or may be different, for the electronic devices 102, 104, and 106.

The electronic device 102 may send one or more messages to the messaging group 310, which may include other devices such as the electronic device 104 and the electronic device 106. Before sending the message, the electronic device 102 may determine whether the intended recipient(s) can receive messages via the internet-based messaging protocol. In some examples, the sender (e.g., the electronic device 102) may query a server associated with the internet-based messaging protocol (e.g., the server 108) and/or the recipient (e.g., the electronic device 104 and/or the electronic device 106) directly to confirm whether the recipient supports the messaging protocol. If it does, the message may be generated and sent via the internet-based messaging protocol. However, if the recipient does not support the protocol, the electronic device 102 may revert to a cellular messaging protocol (e.g., SMS or MMS) for message delivery. If the electronic device 102 is messaging multiple devices, some of which do not support the internet-based messaging protocol, the electronic device 102 may generate separate messages for each messaging protocol (e.g., one for the internet-based messaging protocol and one for the cellular messaging protocol). In this instance, the devices that support the internet-based messaging protocol may receive two copies of the message, one received over the internet-based messaging protocol, and one received over cellular-based messaging protocol.

The internet-based messaging protocol message 302 may include a body, including text, media (e.g., photos or videos), metadata (e.g., message effects or identifiers of other relevant messages), and the like, and may also include an identifier (e.g., a UUID). The identifier may be unique to the messaging group 310 and may serve purposes such as helping to keep track of the message's status (e.g., whether it has been sent, received, or read) and supporting message order maintenance in the message thread (e.g., the list of messages exchanged between participants) of the messaging group 310. The message 302 may then be encoded into a data packet by the messaging application and sent to its destination (e.g., the electronic device 106) over a network (e.g., the network 110) via the internet-based messaging protocol. Sending the message 302 may involve direct communication between devices (e.g., peer-to-peer) or communication mediated by a server (e.g., the server 108). In one or more implementations, the message 302 transmitted via the internet-based messaging protocol may be end-to-end encrypted.

Similarly, the messages 304, 306 may include a body including text, media, metadata, and the like, as permitted by the more limited cellular messaging protocol. The messages 304, 306 may also include a unique identifier. If the cellular messaging protocol messages 304, 306 have a corresponding internet-based messaging protocol message 302, as shown in FIG. 3, the identifier may be the same as the identifier in the corresponding internet-based messaging protocol message 302.

In some examples, the identifier may be replicated across multiple portions of the cellular messaging protocol messages 304, 306. For example, one or more header fields (e.g., content identifier field, content location field, etc.) of the messages 304, 306 may be sent including the identifier in case of any modification (e.g., by the cellular carrier 308) of the messages 304, 306 in transit. The messages 304, 306 may then be encoded and sent to their destinations (e.g., the electronic device 104 and the electronic device 106) according to the cellular carrier 308. In one or more implementations, there may be any number of cellular carriers that facilitate communication of messages to subscriber devices.

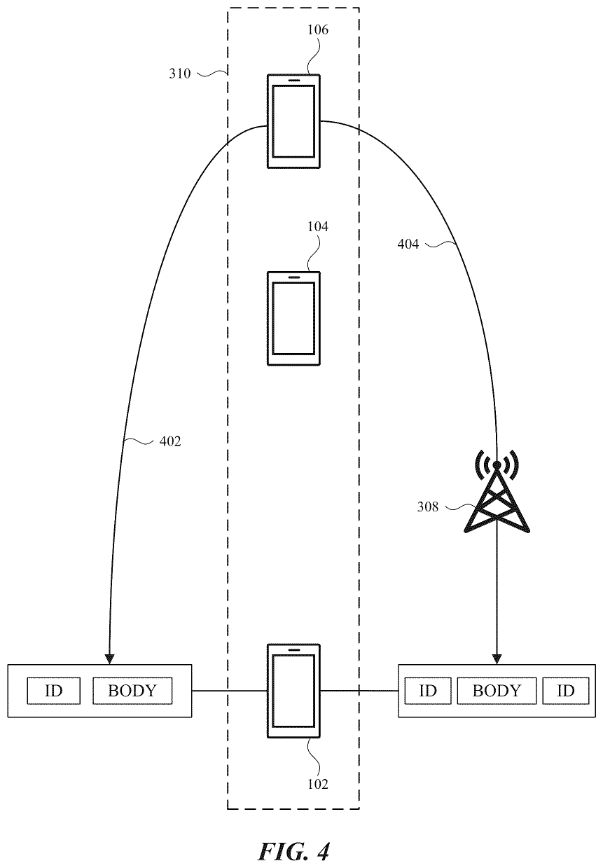

FIG. 4 depicts an example of the electronic device 102 receiving messages from another electronic device (e.g., the electronic device 106) in the messaging group 310 via multiple messaging protocols, in accordance with one or more implementations. For explanatory purposes, FIG. 4 is primarily described herein with reference to the electronic device 102, the electronic device 104, and the electronic device 106 of FIG. 1 in a messaging group 310. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 106 may generate separate messages (e.g., an internet-based messaging protocol message 402 and a cellular messaging protocol message 404) for each messaging protocol as described above with respect to FIG. 3. The electronic device 102 may receive the message 402 (e.g., via the internet-based messaging protocol) and the message 404 (e.g., via the cellular messaging protocol) simultaneously or at different times. For example, the internet-based messaging protocol message 402 may typically arrive before the cellular messaging protocol message 404 because the internet-based messaging protocol message 402 may be transmitted directly to the electronic device 102 rather than via the cellular carrier 308.

In some implementations, if one version of the message does not include contents that cannot be represented in another version of the message, then only one version of the message may be generated. For example, if the message content to be sent via the internet-based messaging protocol message 402 is plain text, then the electronic device 106 may only generate the cellular messaging protocol message 404 since cellular messaging protocol message 404 supports plain text message content. In some implementations, however, both versions of the message may periodically be sent, for example, to refresh group identity metadata (e.g., group photo and group name) or other data that may only be sent as part of the internet-based messaging protocol message 402, even if the message content being sent via the internet-based messaging protocol message 402 is plain text, for example.

When the message 402 and/or the message 404 are received, the electronic device 102 may extract the identifier from the messages 402, 404. If the identifier of the message 404 cannot be found (e.g., due to data corruption or modification by the cellular carrier 308), the electronic device 102 may extract the identifier from one or more other locations in the message 404 (e.g., another field in a header of the message 404).

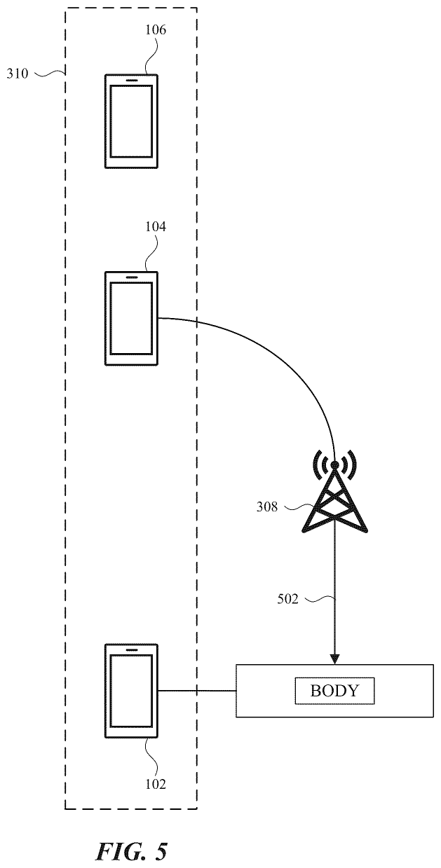

FIG. 5 depicts an example of the electronic device 102 receiving a message from another electronic device (e.g., the electronic device 104) in the messaging group 310 via a single messaging protocol, in accordance with one or more implementations. For explanatory purposes, FIG. 5 is primarily described herein with reference to the electronic device 102, the electronic device 104, and the electronic device 106 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Because the electronic device 104 may only send messages via the cellular messaging protocol, the electronic device 104 may only generate the message 502 as described above with respect to FIG. 3. Accordingly, the electronic device 102 may receive the message 502 via the cellular carrier 308.

When the message 502 is received, the electronic device 102 may generate an identifier from the message 502 because the electronic device 104 may not insert an identifier into the message 502. Generating an identifier may include calculating a hash based on at least part of the message 502 (e.g., part of the body and/or attributes of the message 502).

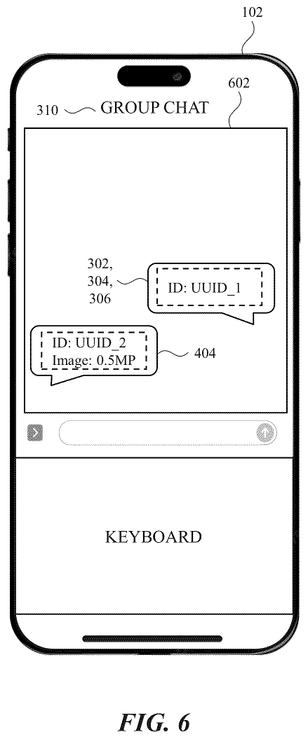

FIG. 6 depicts an example message thread of the electronic device 102 sending a message to other electronic devices (e.g., the electronic device 104 and the electronic device 106) in a messaging group 310 via multiple messaging protocols and receiving a message from the electronic device 106 via a messaging protocol, in accordance with one or more implementations. For explanatory purposes, FIG. 6 is primarily described herein with reference to the electronic device 102, the electronic device 104, and the electronic device 106 of FIG. 1 in a messaging group 310. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Sending a message (e.g., the messages 302, 304, 306) to other electronic devices via multiple messaging protocols may be performed in a manner as described above with respect to FIG. 3. The messages 302, 304, 306 may be assigned an identifier of UUID_1 and added to the message thread 602 of the messaging application running on the electronic device 102. In some examples, the messages 302, 304, 306, may be represented as a single interface element (e.g., message bubble) in the message thread 602 and may include an indication that the messages 302, 304, 306 were sent via multiple messaging protocols.

Receiving the message 404 from the electronic device 106 via the cellular messaging protocol may be performed in a manner as described above with respect to FIG. 4. Because the message 404 was sent by the electronic device 106 capable of sending messages via the internet-based messaging protocol, the message 404 may include an identifier, in this case UUID_2.

As shown in FIG. 6, the message 404 was received before the message 402. In some examples, the electronic device 102 may add the message 404 to the message thread 602 of the messaging application when it is received. In other examples, before the message 404 is added to the message thread 602, the electronic device 102 may store the message 404 in a cache (e.g., in memory 204) until the message 402 is received, or for a predetermined period of time, to avoid duplicate messages in the message thread 602. Similarly, if the message 402 is received before the message 404, the message 402 may be added to the message thread 602 upon receipt or stored in a cache until the message 404 is received or for a predetermined period of time. If both the message 402 and message 404 are stored in a cache, the electronic device 102 may select the message corresponding to a preferred messaging protocol (e.g., the internet-based messaging protocol may be preferred as it can communicate more information in a message) and add the selected message to the message thread 602.

In some implementations, a message received via one protocol may not be added to the message thread 602 until a corresponding message is received via another protocol. For example, when the message 402 is received, the electronic device 102 may not add the message 402 to the message thread 602 until the message 404 is received. Waiting until both messages are received before adding one or more versions to the message thread 602 may help prevent a message from being presented to the user if, for example, the user has the sender blocked at the carrier level or there exists some other behavior that would have restricted one or more versions of the message from reaching or being presented to the user.

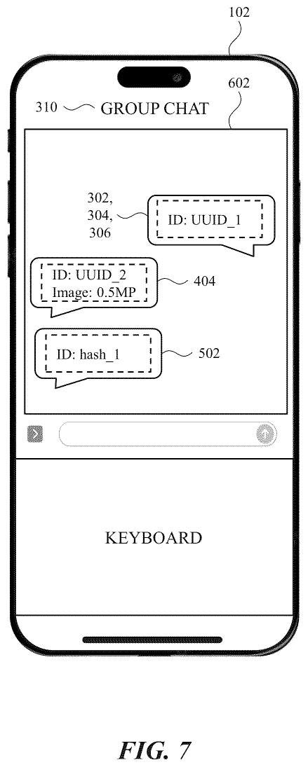

FIG. 7 depicts an example message thread 602 of an electronic device 102 receiving a message from another electronic device in a messaging group 310 via a messaging protocol, in accordance with one or more implementations. For explanatory purposes, FIG. 7 is primarily described herein with reference to the electronic device 102, the electronic device 104, and the electronic device 106 of FIG. 1 in a messaging group 310. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

When the electronic device 102 receives a message from an electronic device that is not capable of sending messages via the internet-based messaging protocol, the message may be added to the message thread 602 of the messaging application. For example, when the electronic device 102 receives the message 502 from the electronic device 104 via the cellular messaging protocol, the electronic device 102 adds the message 502 to the message thread 602.

During or before adding the message 502 to the message thread 602, the electronic device 102 may generate an identifier based on the message 502 for identifying the message in the message thread 602. To generate the identifier, the electronic device 102 may calculate a hash (e.g., hash_1) based on the contents and/or attributes of the message 502. For example, the electronic device 102 may hash the body of the message 502. Because the hash is generated based on the message 502, each recipient of the message 502 may arrive at the same identifier for the message 502 and thus can reference the message 502 in the message thread 602 (e.g., to reply and/or react to the message 502) in subsequent messages.

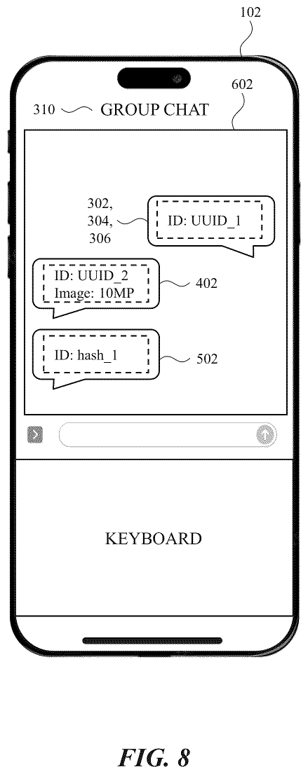

FIG. 8 depicts an example message thread 602 of an electronic device 102 updating a previously received message, in accordance with one or more implementations. For explanatory purposes, FIG. 8 is primarily described herein with reference to the electronic device 102, the electronic device 104, and the electronic device 106 of FIG. 1 in in a messaging group 310. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As described above with respect to FIG. 6, the message 404 may be received before the message 402. The message 404 may be added to the message thread 602 before the message 402 is received so that the user may be presented with the message contents as soon as possible. When the message 402 arrives, however, the message 404 may be replaced with the message 402 if the message 402 includes, for example, more data.

For example, the message 404 may include a low-resolution image, which may have been downsampled from the original image to meet carrier file size constraints. The electronic device 102 may present the low-resolution image in the message thread 602. Subsequently, the electronic device 102 may receive the message 402 including the original image. Because the message 402 has more data than the message 404 (e.g., 10 megapixels in the original image vs. 0.5 megapixels in the downsampled version of the original image), the electronic device 102 may replace at least the image in the message thread 602 so that the user receives the highest quality message contents.

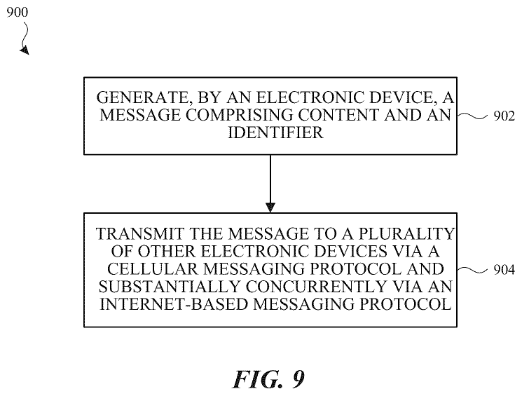

FIG. 9 depicts a flow diagram of an example process 900 for sending group messages in a hybrid group, in accordance with one or more implementations. For explanatory purposes, the process 900 is primarily described herein with reference to the electronic device 102, the electronic device 104, the electronic device 106, and the server 108 of FIG. 1. However, the process 900 is not limited to the electronic device 102, the electronic device 104, the electronic device 106, or the server 108, and one or more blocks of the process 900 may be performed by one or more other components of the server 108, and/or by other suitable devices. Further, for explanatory purposes, the blocks of the process 900 are described herein as occurring sequentially or linearly. However, multiple blocks of the process 900 may occur in parallel. In addition, the blocks of the process 900 need not be performed in the order shown and/or one or more blocks of the process 900 need not be performed and/or can be replaced by other operations.

Internet-based messaging protocols may utilize an existing internet connection to send and receive messages. Internet-based messaging protocols may allow for rich communication experiences, including the ability to send and receive multimedia content like images, audio, video, documents, and the like. Furthermore, internet-based messaging protocols may offer additional features like read receipts, typing indicators, group chats, and end-to-end encryption.

Cellular messaging protocols, like SMS and MMS, may operate over a cellular network (e.g., utilizing cellular carrier devices such as cell sites or transceiver stations), independent of an internet connection. Cellular messaging protocols typically offer fewer features compared to internet-based messaging protocols and are usually not end-to-end encrypted.

At block 902, an electronic device (e.g., the electronic device 102) generates a message including content and an identifier. The message content may be the main body of information to be communicated. The message content could be any form of data, such as a text string, a multimedia file (e.g., an image or video), complex structured data (e.g., in formats like JSON or XML), and the like. The content may be subject to various processes such as encoding or serialization, to ensure that it can be correctly interpreted by the recipient electronic device.

The identifier may be a unique tag associated with the message and may serve multiple purposes. For example, the identifier may be used to track the message through various stages of processing and delivery. The identifier may also be used to ensure that the message is processed in the correct order, or to distinguish between different versions of the same message. The identifier may serve as a tool for error detection and correction, as well, ensuring that a message has not been tampered with during transmission. The identifier may be generated using a predetermined scheme. The identifier may be a sequential number or may be based on more complex factors such as the timestamp of the message creation, the message contents, the sender's identity, cryptographic techniques for added security, and the like.

Once the content and identifier are generated, the content and the identifier may be combined to generate the message. Generating the message may include attaching the identifier as a header and/or footer to the message content and/or embedding it within the content. In some examples, the identifier may be placed in multiple portions of the message for redundancy in case the message is modified in transit.

In some examples, the electronic device may identify a first set of recipients that support the cellular messaging protocol (e.g., the electronic device 104 and the electronic device 106) and a second set of recipients that support the internet-based messaging protocol (e.g., the electronic device 106). For example, the electronic device may query a server (e.g., the server 108) associated with the internet-based massaging protocol with one or more identifiers of the recipients to identify which of the recipients support the internet-based messaging protocol. The electronic device may generate a message to be sent to the first set of recipients via the cellular messaging protocol and a corresponding message to be sent to the second set of recipients via the internet-based messaging protocol. The messages may include the same identifier, for example, to avoid duplicate messages in the event that a recipient is in both the first set of recipients and the second set of recipients. However, in some examples, the message may be a text message (e.g., a message only including text), in which case the electronic device may only generate a message to send to the first set and second set of recipients via the cellular messaging protocol.

At block 904, the message(s) may be transmitted to a plurality of other electronic devices via a cellular messaging protocol and/or substantially concurrently via an internet-based messaging protocol.

In some examples, the message may be generated with one or more characteristics, features, and any other attributes that are supported by the internet-based messaging protocol but not the cellular messaging protocol. The attributes may include reactions (e.g., thumbs up), replies (e.g., responses to particular messages), effects (e.g., motion-based text effects), group name (e.g., name associated with the messaging group), group photo (e.g., photo associated with the messaging group), and the like in a predetermined list of attributes. To send a message that includes one or more of such attributes to the first set of recipients, the message may be converted such that the content of the message includes a text-based representation of the attributes. For example, the message may state “User liked a message” rather than causing the recipient to display a thumbs up icon next to the applicable message. To send a message that includes one or more of such attributes to the second set of recipients, the electronic device may send the message via the internet-based messaging protocol and forgo sending the message via the cellular messaging protocol to reduce the number of messages received by the second set of recipients.

In some examples, the message may be a text message (e.g., a message only including text), in which case the electronic device may send the message to the first set and second set of recipients via only the cellular messaging protocol to reduce the load on that servers that facilitate the internet-based messaging protocol.

In some examples, the message may include an indication that it was sent via the cellular messaging protocol and/or the internet-based messaging protocol. The indication may include an icon, text, color, shape, effect, and the like, which may indicate that the message was sent via an unencrypted channel (e.g., the cellular messaging protocol). For example, the message may be displayed in a message thread as a green text bubble to indicate that the message was sent via an unencrypted channel or has a counterpart message that was sent via an unencrypted channel. The indication may be different than an indication that a message was sent only via an encrypted channel (e.g., the internet-based messaging protocol).

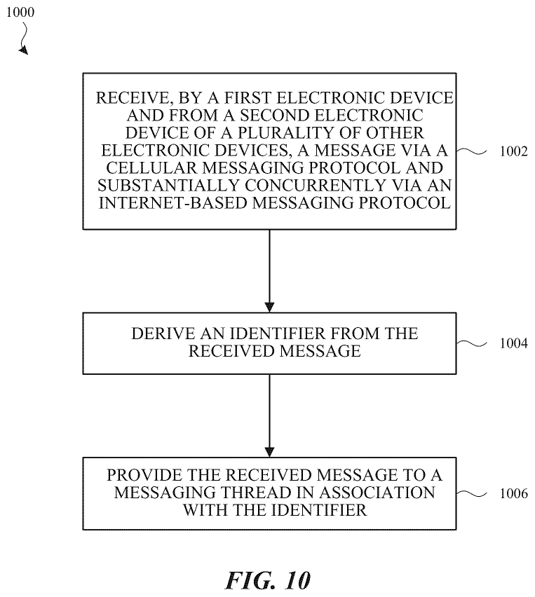

FIG. 10 depicts a flow diagram of an example process 1000 for receiving group messages in a hybrid group, in accordance with one or more implementations. For explanatory purposes, the process 1000 is primarily described herein with reference to the electronic device 102, the electronic device 104, the electronic device 106, and the server 108 of FIG. 1. However, the process 1000 is not limited to the electronic device 102, the electronic device 104, the electronic device 106, or the server 108, and one or more blocks of the process 1000 may be performed by one or more other components of the server 108, and/or by other suitable devices. Further, for explanatory purposes, the blocks of the process 1000 are described herein as occurring sequentially or linearly. However, multiple blocks of the process 1000 may occur in parallel. In addition, the blocks of the process 1000 need not be performed in the order shown and/or one or more blocks of the process 1000 need not be performed and/or can be replaced by other operations.

At block 1002, an electronic device (e.g., the electronic device 102) may receive (e.g., from the electronic device 106) a message via a cellular messaging protocol (e.g., message 402) and substantially concurrently via an internet-based messaging protocol (e.g., the message 404). A set of corresponding messages (e.g., messages 402, 404) may include the same content but include different structures, metadata, and the like, according to the messaging protocol by which they were sent. For example, the message sent via the cellular messaging protocol may include multiple copies of the identifier of the message whereas the message sent via the internet-based messaging protocol may only include one.

In some examples, one message may be received before the other corresponding message, in which case the process 1000 may proceed for each message. For example, if the electronic device first receives a first message via a cellular messaging protocol, the electronic device may perform block 1004 and block 1006 with the first message. Then when the electronic device receives the corresponding second message via an internet-based messaging protocol, the electronic device may perform block 1004 and block 1006 with the second message.

In some examples, when one message is received before a corresponding message, the message may be placed in a buffer until the corresponding message arrives (e.g., as determined by the messages including the same identifier) and/or until a threshold amount of time passes.

At block 1004, the electronic device may extract, generate, or otherwise derive an identifier from the received message. The identifier may be a unique string of characters associated with the message that allows the electronic device to distinguish the message from other messages. In some examples, the identifier may be included directly in the message data, for example, embedded within the message header or metadata. In such cases, the electronic device may extract this identifier upon receipt of the message.

In some examples, the identifier may not be explicitly included in the message (e.g., the message 502). Instead, the recipient device may generate an identifier based on characteristics of the message. This may include hashing at least some part of the message, such as its content, timestamp, and/or other attributes, to generate a unique identifier. Generating the identifier may be done in such a way that other recipients of the message in the group message may generate the same or similar identifier so that participants in the group message may reference the message via the generated identifier. For example, the devices may use a predetermined hash function on a predetermined portion of the message to generate the identifier.

Once the identifier has been derived, the identifier can be used for various purposes, such as organizing messages, eliminating duplicate messages, synchronizing messages across multiple devices, tracking message delivery status, and the like.

At block 1006, the electronic device may place, insert, copy, transfer, display, or otherwise provide the message to a message thread (e.g., message thread 602). The message thread may include a set (e.g., chronological sequence) of related messages (e.g., organized around a particular conversation of a group of participants). Each message within the message thread may be associated with an identifier (e.g., the identifier derived from the respective message) that allows the electronic device to maintain the correct sequence and context of the messages.

In some examples, if the message thread includes another message that includes the identifier and that other message was received via the internet-based messaging protocol, the message may be discarded as a redundant message.

In some examples, if the message thread includes another message that includes the identifier and that other message was received via the cellular messaging protocol (e.g., the other message corresponds to the message and was sent via another messaging protocol), the electronic device may replace at least part of the other message with at least part of the message. For example, if the other message includes a thumbnail image, the electronic device may replace the thumbnail image with a video from the message. The video may be placed in the message thread at the same interface element as the thumbnail.

In some examples, the message may relate to another message in the message thread that does not correspond to the message (e.g., the message contains its identifier to identify itself and the identifier of another message to which the message pertains), and the message may cause a modification to the other message. For example, the message may include instructions to add a heart icon to the other message in the message thread.

FIG. 11 depicts an example electronic system 1100 with which aspects of the present disclosure may be implemented, in accordance with one or more implementations. The electronic system 1100 can be, and/or can be a part of, any electronic device for generating the features and processes described in reference to FIGS. 1-10, including but not limited to a laptop computer, tablet computer, smartphone, and wearable device (e.g., smartwatch, fitness band). The electronic system 1100 may include various types of computer-readable media and interfaces for various other types of computer-readable media. The electronic system 1100 includes one or more processing unit(s) 1114, a persistent storage device 1102, a system memory 1104 (and/or buffer), an input device interface 1106, an output device interface 1108, a bus 1110, a ROM 1112, one or more processing unit(s) 1114, one or more network interface(s) 1116, one or more sensors 1118, and/or subsets and variations thereof.

The bus 1110 collectively represents all system, peripheral, and chipset buses that communicatively connect the numerous internal devices of the electronic system 1100. In one or more implementations, the bus 1110 communicatively connects the one or more processing unit(s) 1114 with the ROM 1112, the system memory 1104, and the persistent storage device 1102. From these various memory units, the one or more processing unit(s) 1114 retrieves instructions to execute and data to process in order to execute the processes of the subject disclosure. The one or more processing unit(s) 1114 can be a single processor or a multi-core processor in different implementations.

The ROM 1112 stores static data and instructions that are needed by the one or more processing unit(s) 1114 and other modules of the electronic system 1100. The persistent storage device 1102, on the other hand, may be a read-and-write memory device. The persistent storage device 1102 may be a non-volatile memory unit that stores instructions and data even when the electronic system 1100 is off. In one or more implementations, a mass-storage device (such as a magnetic or optical disk and its corresponding disk drive) may be used as the persistent storage device 1102.

In one or more implementations, a removable storage device (such as a flash drive) may be used as the persistent storage device 1102. Like the persistent storage device 1102, the system memory 1104 may be a read-and-write memory device. However, unlike the persistent storage device 1102, the system memory 1104 may be a volatile read-and-write memory, such as RAM. The system memory 1104 may store any of the instructions and data that one or more processing unit(s) 1114 may need at runtime. In one or more implementations, the processes of the subject disclosure are stored in the system memory 1104, the persistent storage device 1102, and/or the ROM 1112. From these various memory units, the one or more processing unit(s) 1114 retrieves instructions to execute and data to process in order to execute the processes of one or more implementations.

The bus 1110 also connects to the input device interfaces 1106 and output device interfaces 1108. The input device interface 1106 enables a user to communicate information and select commands to the electronic system 1100. Input devices that may be used with the input device interface 1106 may include, for example, alphanumeric keyboards, touch screens, and pointing devices. The output device interface 1108 may enable the electronic system 1100 to communicate information to users. For example, the output device interface 1108 may provide the display of images generated by electronic system 1100. Output devices that may be used with the output device interface 1108 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1110 also connects to sensor(s) 1118. The sensor(s) 1118 may include a microphone and/or camera. The microphone may be used to capture audio from a user, for example, to dictate messages to send to electronic devices in a messaging group. The camera may be used to capture images, for example, to send to electronic devices in a messaging group.

Finally, as shown in FIG. 11, the bus 1110 also couples the electronic system 1100 to one or more networks and/or to one or more network nodes through the one or more network interface(s) 1116. In this manner, the electronic system 1100 can be a part of a network of computers (such as a local area network, a wide area network, an Intranet, or a network of networks, such as the internet). Any or all components of the electronic system 1100 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
generating, by an electronic device, a message comprising content and an identifier; and
transmitting the message to a plurality of other electronic devices via a cellular messaging protocol and substantially concurrently via an internet-based messaging protocol.

2. The method of claim 1, further comprising:
before transmitting the message:
identifying a first set of electronic devices from the plurality of other electronic devices that support the cellular messaging protocol and a second set of electronic devices from the plurality of other electronic devices that support the internet-based messaging protocol.

3. The method of claim 2, wherein identifying the second set of electronic devices from the plurality of other electronic devices comprises querying a server associated with the internet-based messaging protocol with an identifier of an electronic device.

4. The method of claim 2, wherein transmitting the message includes transmitting the message via the internet-based messaging protocol and forgoing transmitting the message via the cellular messaging protocol for the second set, in response to the message including an attribute in a predetermined list of attributes.

5. The method of claim 2, wherein transmitting the message includes transmitting the message via the cellular messaging protocol and forgoing transmitting the message via the internet-based messaging protocol for the first set and the second set, in response to the message only including text.

6. The method of claim 1, wherein the message comprises the identifier in multiple portions of the message.

7. The method of claim 1, wherein the message further comprises an indication that the message is to be sent via the cellular messaging protocol and the internet-based messaging protocol, the indication being different than an indication that the message is to be sent via only the internet-based messaging protocol.

8. The method of claim 1, wherein the internet-based messaging protocol is end-to-end encrypted.

9. The method of claim 1, wherein the cellular messaging protocol utilizes one or more cellular carrier devices for transmitting the message.

10. An electronic device comprising:
a processor configured to:
generate a message comprising content and an identifier; and
transmit the message to a plurality of other electronic devices via a cellular messaging protocol and substantially concurrently via an internet-based messaging protocol.

11. The electronic device of claim 10, wherein the processor is further configured to:
before transmitting the message:
identify a first set of electronic devices from the plurality of other electronic devices that support the cellular messaging protocol and a second set of electronic devices from the plurality of other electronic devices that support the internet-based messaging protocol.

12. The electronic device of claim 11, wherein identifying the second set of electronic devices from the plurality of other electronic devices comprises querying a server associated with the internet-based messaging protocol with an identifier of an electronic device.

13. The electronic device of claim 11, wherein transmitting the message includes transmitting the message via the internet-based messaging protocol and forgoing transmitting the message via the cellular messaging protocol for the second set, in response to the message including an attribute in a predetermined list of attributes.

14. A non-transitory computer-readable medium storing instructions that, when executed by a processor, cause the processor to perform operations comprising:
receiving, by a first electronic device and from a second electronic device of a plurality of other electronic devices, a message via a cellular messaging protocol and substantially concurrently via an internet-based messaging protocol;
deriving an identifier from the received message; and
providing the received message to a message thread in association with the identifier.

15. The non-transitory computer-readable medium of claim 14, wherein providing the received message to the message thread comprises:
discarding the received message, in response to determining that the message thread includes a message that includes the identifier and was received via the internet-based messaging protocol.

16. The non-transitory computer-readable medium of claim 14, wherein providing the received message to the message thread comprises:
replacing at least part of an existing message in the message thread with at least part of the received message, in response to determining that the message thread includes the existing message that includes the identifier and was received via the cellular messaging protocol.

17. The non-transitory computer-readable medium of claim 14, wherein the instructions cause the processor to perform operations further comprising:
receiving a second message via the cellular messaging protocol; and
deriving an identifier from the second message by generating a hash based on one or more attributes of the received message.

18. The non-transitory computer-readable medium of claim 17, wherein deriving the identifier from the received message comprises:
obtaining the identifier from a first portion of the received message; and
in response to the first portion of the received message not including the identifier, obtaining the identifier from a second portion of the received message.

19. The non-transitory computer-readable medium of claim 14, wherein the instructions cause the processor to perform operations further comprising:
modifying at least part of an existing message in the message thread based on the received message, in response to determining that the existing message includes the identifier.

20. The non-transitory computer-readable medium of claim 14, wherein the instructions cause the processor to perform operations further comprising:
in response to receiving the message via the internet-based messaging protocol, storing the message in a cache until the message is received via the cellular messaging protocol.
